(19) United States
(12) Patent Application Publication
(10) Pub. No.: US 2017/0220476 A1
(43) Pub. Date: Aug. 3, 2017

(54) Systems and Methods for Data Caching in Storage Array Systems

(71) Applicant: NetApp, Inc., Sunnyvale, CA (US)

(72) Inventors: Yanling Qi, Austin, TX (US); Junjie Qian, Wichita, KS (US); Somasundaram Krishnasamy, Austin, TX (US)

(21) Appl. No.: 15/010,928

(22) Filed: Jan. 29, 2016

(51) Int. Cl. G06F 12/08; G06F 3/06

(52) U.S. Cl. CPC G06F 12/0888; G06F 12/0891; G06F 12/0893; G06F 12/0813; G06F 3/0611; G06F 3/0647; G06F 3/0659; G06F 3/067; G06F 3/0685; G06F 2212/1024; G06F 2212/154; G06F 2212/60; G06F 2212/62

(57) ABSTRACT

A method includes: communicating read requests from a host device to either a storage array controller or a data cache associated with the host device; classifying portions of data, in response to the read requests, according to frequency of access of the respective portions of data; and causing the storage array controller to either promote a first portion of data to a data cache associated with the storage array controller or demote the first portion of data from the data cache associated with the storage array controller in response to a change in cache status of the first portion of data at the data cache associated with the host device and in response to frequency of access of the first portion of data.

### TECHNICAL FIELD

The present description relates to data storage and, more specifically, to systems, methods, and machine-readable media for caching application data at a host system and at a storage array system.

### BACKGROUND

Networks and distributed storage allow data and storage space to be shared between devices located anywhere a connection is available. Improvements in capacity and network speeds have enabled a move away from locally attached storage devices and towards centralized storage repositories such as cloud-based data storage. These centralized offerings deliver the promised advantages of security, worldwide accessibility, and data redundancy. To provide these services, storage systems may incorporate Network Attached Storage (NAS) devices, Storage Area Network (SAN) devices, and other configurations of storage elements and controllers in order to provide data and manage its flow.

One example conventional system uses cache memory at an application server to speed up read requests. For instance, the conventional system may use flash memory or other electronically readable memory at the application server to store data that is most frequently accessed. When an application issues a read request for a particular piece of data, the system checks to see if that data is within the cache. If the data is stored in the cache, then the data is read from the cache memory and returned to the application. This is generally faster than satisfying the read request by accessing the data from a storage array of hard disk drives (HDDs) and/or solid state drives (SSDs).

Server side cache management software allows a non-volatile memory device coupled to an application server to act as a cache for the primary storage provided by the storage array. When application I/O requests are to be served and the requested data is already in the cache device, it is called cache-hit. Otherwise, it is a cache-miss case. The I/O request is served from the cache device for cache hit use case. For cache-miss, the I/O request is served from the slower primary data source. A problem with the conventional server side flash cache solution is a lack of guaranteed I/O service time. When a cache miss occurs, data is read from back-end storage (the array), increasing latency for that particular I/O operation

Cache misses may be caused by an incorrect cache warm-up phase. In such a scenario, the caching algorithm fails to make a correct prediction as to which application data is most likely to be read and should, therefore, be placed in cache. Another cause is that sometimes the size of the “hot” or frequently accessed data—also known as the working set—is larger than the size of the cache devices. Because of this factor, host side cache management software invalidates some cached data in the cache device to make room for new data extents to be cached. Since the invalidated cache data is part of an application working set, cache miss is likely to occur in future application data access.

Accordingly, the potential remains for improvements that, for example, result in a storage system that provides for better access for the application data set.

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2 is an architectural diagram focusing on caching aspects of storage system 102 of FIG. 1 according to various embodiments of the present disclosure.

FIGS. 3-6 provide an illustration of an example process of caching data, according to various embodiments.

FIG. 7 is a functional block diagram to show host cache management software and array cache management software, according to various embodiments.

FIG. 8 is a flow diagram of a method for caching data according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for improving the, operation of storage array systems by providing for a cache system having a storage array cache and a host cache, Some embodiments include systems and methods to integrate host cache management and storage array cache management together to make the cache on the storage array operate as an extension to the host cache to create a unified cache system. Host-invalidated cache data may be cached at the storage array. When an application I/O request misses the host side cache, it may then hit the array side cache, thereby returning the requested data to the host via the array side cache so that a predictable Quality of Service (QoS) level can be satisfied.

System configuration may include configuring individual storage volumes to support the read cache feature. After this feature is enabled for a given volume or a given set of volumes, the host side cache management software (e.g., at an application server or other host) manages the array side cache for those volumes.

The unified cache management technique of this example considers the array side cache as an extension to the host side cache. Since the unified cache is physically associated with two different locations (host side and array side), each with different performance characteristics, the following principles may be applied: first, a given portion of data is cached either on the array side or the host side, but not both. When data extents are promoted to and reside in the host side cache, those data extents are not also cached in the array's cache. This principle optimizes flash device resource utilization by not double-storing data extents. Second, the array side cache contains data extents which are demoted from the host side cache. In fact, in some embodiments, the array side cache contains only data extents to have been demoted from the host side cache.

In the example herein, data promotion refers to the operation wherein the cache management software moves data extents from the primary data store to a cache device. The next I/O request to the data extents results in a cache hit so that the I/O request is served from the cached data. Data promotion is also sometimes referred to as cache fill, cache population, or cache warm-up. Further in this example, the cache demotion includes operations that remove cached data extents from one or more caches. Cache demotion may also be referred to as cache eviction, cache reclamation, cache deletion, or cache removing. The demotion operation usually happens in cache stressed conditions for making room to store more frequently accessed data. It is generally expected that demoted cache data is likely to be re-accessed within the near future. These concepts are described further below in more detail.

The various embodiments also include methods for operating the array side cache and host side cache to provide a unified system cache. An example method includes populating the host side cache with the working set during operation so that read requests are fulfilled through the cache. The host side cache management software keeps track of the frequency of access of each of the data extents. When the host side cache management software determines that a given data extent that is not already cached should be cached, it caches that data extent and it demotes another data extent that has a lower frequency of access. The demotion process includes evicting the data extent with the lower frequency of access from the host side cache and instructing the array side cache management to promote that data extent from primary storage. Thus, the data extent is evicted from the host side cache but is now included in the array side cache.

Further during operation in this example, the host side cache management software detects that another data extent cached on the array side has become hot and should be promoted to the host side cache. Also, the host side cache management software detects that a data extent currently at the host side cache has become less hot (warm) and should be demoted to the array side cache to make room for the data extent that is being promoted. Accordingly, the host side cache management software reads the hot data extent from the storage array and evicts the warm data extent. In evicting the warm data extent, the host side cache management software instructs the array side cache management software to promote the warm, data extent from the primary storage to the array side cache. In promoting the hot data extent, the host side cache management software instructs the array side cache management software to evict the hot data extent. The result is that the hot data extent is now stored at the host side cache, and the warm data extent is now stored at the array side cache. In the above process, the host side cache management software controls the promotion and demotion at both the host side and the array side to provide a unified cache management.

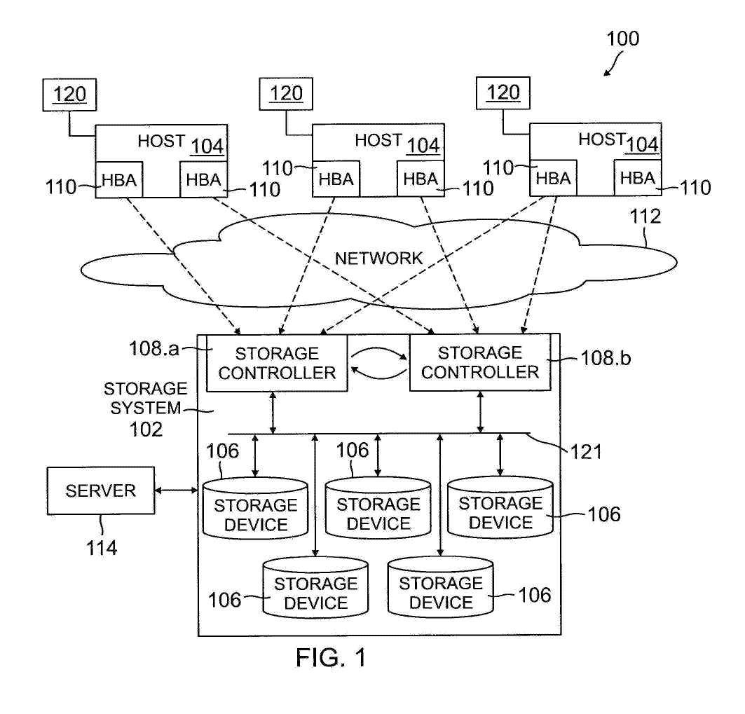

A data storage architecture 100, in which various embodiments may be implemented, is described with reference to FIG. 1. The storage architecture 100 includes a storage system 102 in communication with a number of hosts 104. The storage system 102 is a system that processes data transactions on behalf of other computing systems including one or more hosts, exemplified by the hosts 104. Examples of hosts include application servers, where those applications generate read and write requests for the storage system 102, as well as clients on network 112 that generate read and write requests.

The storage system 102 may receive data transactions (e.g., requests to read and/or write data) from one or more of the hosts 104, and take an action such as reading, writing, or otherwise accessing the requested data. For many exemplary transactions, the storage system 102 returns a response such as requested data and/or a status indictor to the requesting host 104. It is understood that for clarity and ease of explanation, only a single storage system 102 is illustrated, although any number of hosts 104 may be in communication with any number of storage systems 102.

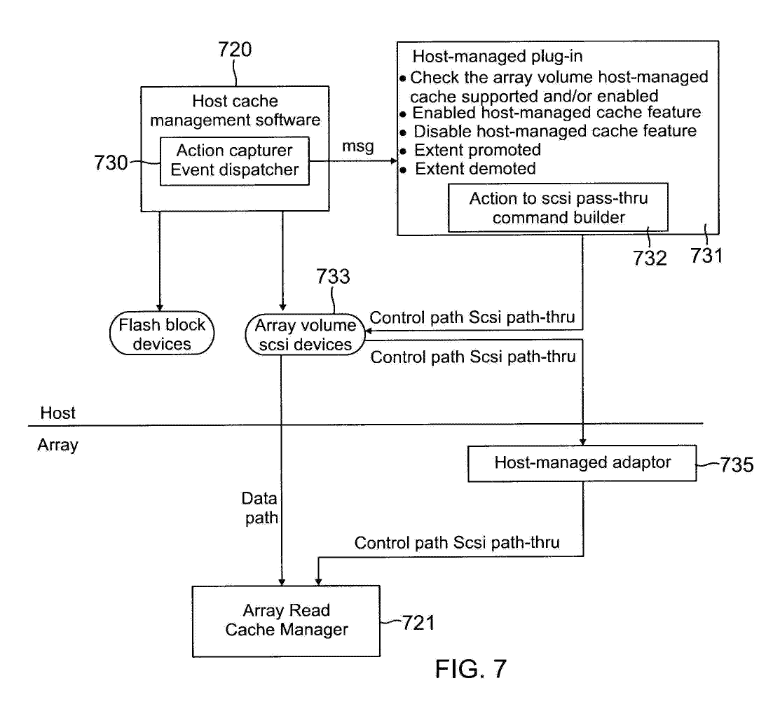

Further in this example, each of the hosts 104 is associated with a host side cache 120 that is managed by host cache management software running on its respective host 104. An example of host cache management software includes components 720 and 731 of FIG. 7. Storage system 102 also includes array side cache 121 that is controlled by array cache management software running on the storage system 102 (e.g., on one or more of storage controllers 108). An example of array cache management software includes components 721 of FIG. 7.

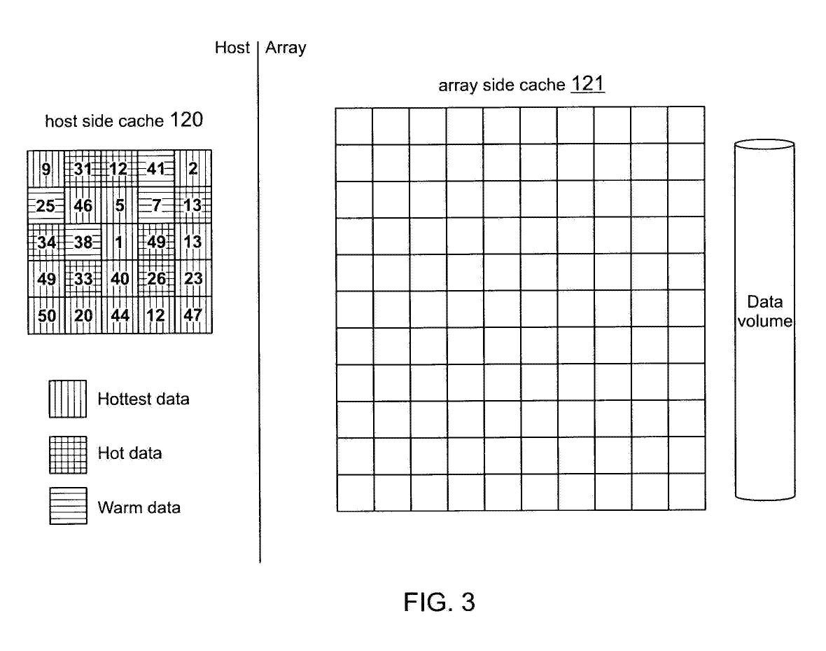

According to the examples herein, the host cache management software communicates with the array cache management software to promote and demote data extents as illustrated in FIGS. 3-6. Host side cache 120 and array side cache 121 may be embodied using any appropriate hardware. In one example cache 120, 121 may be implemented as flash RAM (e.g. NAND EEPROM) or other nonvolatile memory that is in communication with either the host 120 or the storage system 102 on a bus according to Peripheral Component Interconnect express (PCIe) standards or other techniques. Additionally or alternatively, cache 120, 121 may be implemented as a solid-state drive (SSD).

While the storage system 102 and each of the hosts 104 are referred to as singular entities, a storage system 102 or host 104 may include any number of computing devices and may range from a single computing system to a system cluster of any size. Accordingly, each storage system 102 and host 104 includes at least one computing system, which in turn includes a processor such as a microcontroller or a central processing unit (CPU) operable to perform various computing instructions. The instructions may, when executed by the processor, cause the processor to perform various operations described herein with the storage controllers 108.a, 108.b in the storage system 102 in connection with embodiments of the present disclosure, Instructions may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 and responds to one or more hosts 104's data transactions so that the storage devices 106 appear to be directly connected (local) to the hosts 104. In various examples, the storage devices 106 include hard disk drives (HDDs), solid state drives (SSDs), optical drives, and/or any other suitable volatile or non-volatile data storage medium. In some embodiments, the storage devices 106 are relatively homogeneous (e.g., having the same manufacturer, model, and/or configuration). However, it is also common for the storage system 102 to include a heterogeneous set of storage devices 106 that includes storage devices of different media types from different manufacturers with notably different performance.

The storage system 102 may group the storage devices 106 for speed and/or redundancy using a virtualization technique such as RAID (Redundant Array of Independent/Inexpensive Disks). The storage system 102 also includes one or more storage controllers 108.a, 108.b in communication with the storage devices 106 and any respective caches (not shown). The storage controllers 108.a, 108.b exercise low-level control over the storage devices 106 in order to execute (perform) data transactions on behalf of one or more of the hosts 104. The storage controllers 108.a, 108.b are illustrative only; as will be recognized, more or fewer may be used in various embodiments. Having at least two storage controllers 108.a, 108.b may be useful, for example, for failover purposes in the event of equipment failure of either one. The storage system 102 may also be communicatively coupled to a user display for displaying diagnostic information, application output, and/or other suitable data.

In the present example, storage controllers 108.a and 108.b are arranged as an HA pair. Thus, when storage controller 108.a performs a write operation for a host 104, storage controller 108.a also sends a mirroring I/O operation to storage controller 108.b. Similarly, when storage controller 108.b performs a write operation, it also sends a mirroring I/O request to storage controller 108.a.

Moreover, the storage system 102 is communicatively coupled to server 114. The server 114 includes at least one computing system, which in turn includes a processor, for example as discussed above. The computing system may also include a memory device such as one or more of those discussed above, a video controller, a network interface, and/or a user I/O interface coupled to one or more user I/O devices. The server 114 may include a general purpose computer or a special purpose computer and may be embodied, for instance, as a commodity server running a storage operating system. While the server 114 is referred to as a singular entity, the server 114 may include any number of computing devices and may range from a single computing system to a system cluster of any size.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with a storage controller 108.a, 108.b of the storage system 102. The HBA 110 provides an interface for communicating with the storage controller 108.a, 108.b, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. The HBAs 110 of the hosts 104 may be coupled to the storage system 102 by a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), the Internet, Fibre Channel, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., read, write, modify, etc.) remote data, a host HBA 110 sends one or more data transactions to the storage system 102. Data transactions are requests to read, write, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information.

When one of the hosts 104 requests a data extent via a read request, the host cache management software tries to satisfy that read request out of host side cache 120, and if there is a cache miss at the host side cache 120, then the host cache management software communicates with the array cache management software to read the data extent from array side cache 121. If there is a cache miss at array side cache 121, then the read request is sent to storage system 102 to access the data extent from the storage devices 106. The storage system 102 executes the data transactions on behalf of the hosts 104 by reading, writing, or otherwise accessing data on the relevant storage devices 106. A storage system 102 may also execute data transactions based on applications running on the storage system 102 using the storage devices 106. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a Wide Area Network (WAN), and/or a Local Area Network (LAN). Fibre Channel and FCoE are well suited for embodiments where hosts 104 are coupled to the storage system 102 via a direct connection or via Fibre Channel switches. A Storage Attached Network (SAN) device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. It is understood that the scope of present disclosure is not limited to either block-level or file-level protocols, and in many embodiments, the storage system 102 is responsive to a number of different memory transaction protocols.

In an embodiment, the server 114 may also provide data transactions to the storage system 102. Further, the server 114 may be used to configure various aspects of the storage system 102, for example under the direction and input of a user. Some configuration aspects may include definition of RAID group(s), disk pool(s), and volume(s), to name just a few examples.

As noted above, the storage array of FIG. 1 is implemented by storage devices 106, and the array may include many logical volumes storing the data. A volume in the storage array can be configured to support host-managed cache feature through an array management interface provided by either server 114, a host 104, or a stand-alone array management station (not shown) After the configuration operation, the volume is called host managed cache supported volume. A volume in a storage array can be host managed cache feature enabled or disabled. The enabling and disabling host managed cache operation for a volume can be performed by the array management station via array management interface or by the host side flash cache management software by, e.g., a SCSI command via the data path.

At startup of the host cache management software device configuration time of the host cache device, the host side cache management software issues a SCSI command (inquiry or mode sense) to the controllers 108 to request status information regarding whether a volume on the storage array is host managed cache supported and enabled. If so, then read requests to the volume are satisfied by either the array side cache or the host side cache first, and data extents of the working set that are saved to the volume are cached.

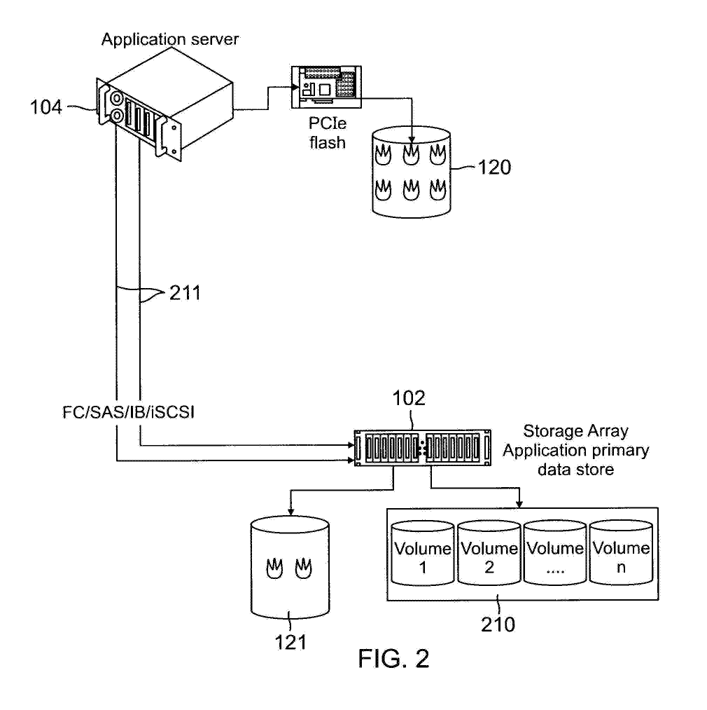

These principles are further illustrated, for example, in FIG. 2 which is an architectural diagram focusing on caching aspects of storage system 102 of FIG. 1 according to various embodiments of the present disclosure. FIG. 2 shows one host 104 for ease of explanation, and it is understood that various embodiments may include any appropriate number of hosts. Host 104 includes cache 120, which in this example is shown as a PCIe caching system. However, the scope of embodiments is not limited to PCIe caching hardware, as any appropriate caching hardware may be used. For instance, various embodiments may use any appropriate nonvolatile random access memory, and some embodiments may even use volatile random access memory.

Host 104 is shown in this example as an application server, although it is understood that hosts may include other nodes that send I/O requests to storage system 102, where examples of those nodes also include network clients (not shown). Host 104 is communicatively coupled to storage system 102 via HBAs and communication channels 211 using one or more protocols, such as Fibre Channel, serial attached SCSI (SAS), iSCSI, or the like. Storage system 102 includes one or more storage controllers and a plurality of storage devices (106, not shown) implemented as an array. In this example, logic in the controllers (108, not shown) of the storage system 102 create virtual volumes 210 on top of the array of physical storage devices, so that a given virtual volume may not correspond one-to-one with a particular physical devices. The virtual volumes 210 are shown as Volume 1-Volume n. Storage system 102 also includes array side cache 121, which may be implemented as a SSD or other appropriate random access memory. In the example of FIG. 2, the virtual volumes 210 are referred to as a primary data store, and it is understood that when data is cached to cache 120, 121 a read request will normally be satisfied through a read of the requested data from cache 120, 121 rather than from virtual volumes 210, assuming that that data is cached.

As in the examples above, caches 120, 121 store the working data set, which is sometimes referred to as hot, data or warm data. Hot data refers to the data with a highest frequency of access in the working set, where as warm data has a lower frequency of access than the hot data, but is nevertheless accessed frequently enough that it is appropriate to be cached. In this example, the hot data is cached at cache 120, and the warm data is cached at cache 121.

The host cache management software tracks frequency of access of the data extents of the working set by counting accesses to specific data extents and recording that as metadata associated with those data extents. The metadata may be stored, e.g., at cache 121 or other appropriate RAM in communication with host 104. Some embodiments may also include array cache management software tracking frequency of access of the data extents and storing metadata. Host cache management software uses that metadata to classify data extents according to their frequency of access and to promote those data extents and demote those data extents according to their frequency of access. Of course, techniques to promote and demote data extents are discussed in more detail with respect'to FIGS. 3-6. Host cache management software and array cache management software communicate with each other over the communication channels 211 using any appropriate protocol, such as Fibre Channel, SAS, iSCSI, or the like.

FIGS. 3-6 provide an illustration of an example process of caching data, according to various embodiments. The actions of FIGS. 3-6 may be performed by a host running host cache management software and/or a storage controller running array cache management software. The actions shown in FIGS. 3-6 are performed by one or more computer processors executing computer readable code and interacting with storage hardware to cache the data. For instance, a host cache management software running on a host, such as host 104 of FIGS. 1-2, may cache data to cache 120 and send commands to storage system 102. Storage system 102 runs array cache management software, receives commands from host cache management software, and promotes or demotes data to cache 121 as appropriate.

The following example assumes that the application data working-set contains 50 data extents named from 1 to 50. The size of the host side cache 120 can only cache 25 data extents. After the host side cache warm-up, 25 application data extents are cached into the host side cache 120. The host side cache management software measures the cached data temperatures and categorizes cached data extents as hottest, hot, and warm as illustrated in FIG. 3. The host side cache 120 capacity is full, as shown in FIG. 3. Further, as shown in FIG. 3, array side cache 121 is larger than host side cache 120, Of course, a data working set of 50 data extents and a host side cache 120 of 25 data extents are just examples. In other embodiments, a working set may be any appropriate size, and sizes for host side cache 120 and array side cache 121 may also be any appropriate size.

As noted above, measuring a cached data temperature may include tracking a number of I/O requests for a particular piece of data by counting those I/O requests over an amount of time and saving metadata to indicate frequency of access. Categorizing cached data extents as hottest, hot, and warm may include classifying those data extents according to their frequency of access, where the most frequently accessed data is hottest, data that is not accessed as frequently as the hottest data may be categorized as hot, and data that is not accessed as frequently as the hot data but is still part of the working set may be categorized as warm. In one example, host side cache management software tracks the frequency of access, updates the metadata, and analyzes that metadata against thresholds to categorize data extents according to their frequency of access.

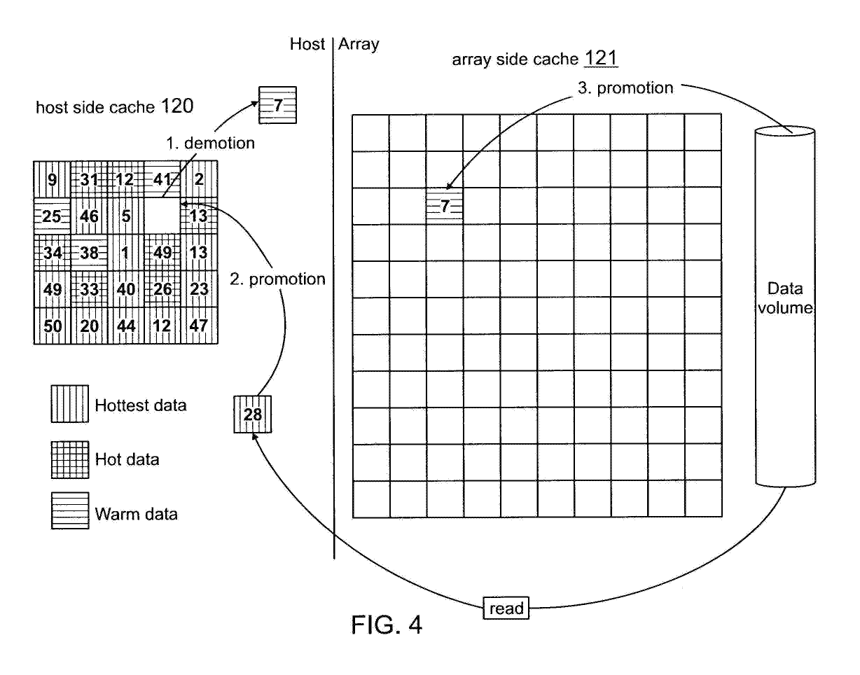

Continuing with the example, the host side cache management software detects that data extent 28 (which is not in host side cache 120 yet) has surpassed a threshold so that it qualifies as hottest. In response to this change in categorization, the host side cache management software determines that it should promote data extent 28 to the host side cache, as illustrated in FIG. 4. The host side management software reads extent 28 from the storage array (or rather, from a data volume such as one of the volumes 210 of FIG. 2). The host side cache management software caches data extent 28 to the host side cache 120 in the cache space that was previously occupied by data extent 7 in FIG. 3. Meanwhile, the demotion of data extent 7 from the host cache is accompanied by a command from the host side cache management software to the array side cache management software to signal to the array side cache management software to promote data extent 7 to the array side cache 121.

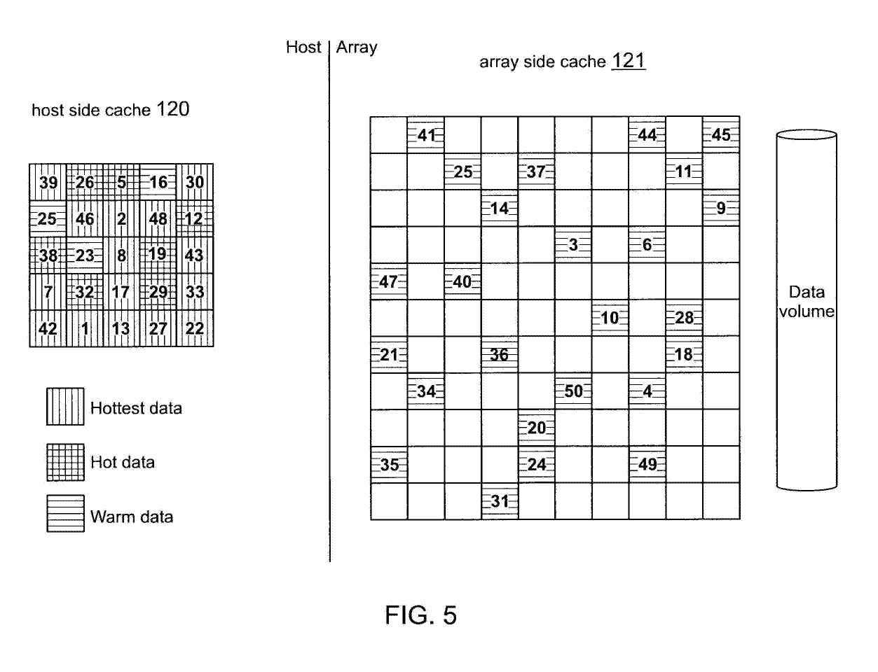

After some time of normal operation, all or nearly all of the application data working set is either cached in the host side cache 120 or in the array side cache 121, as illustrated in FIG. 5. At this time, application I/O requests will either be served from the host side cache 120 or served from the array side cache 121. The hottest data is served from the host side cache 120, which has the lowest I/O latency. The less frequently accessed data is served from the array side cache 121, which has a I/O latency lower than that of the data volume, but slightly higher than that of the host side cache 120.

Continuing with the example in FIG. 5, data extent 31 is classified as warm and is cached in array side cache 121. Also, data extent 16 is classified as warm and is cached in host side cache 120. However, during the application running time, the host side cache management software analyzes the metadata for each of the data extents and detects that the data extent 31 has had an increase in its frequency of access. Therefore, the host side cache management software promotes the data extent 31 to the host side cache 120 in response to the change in frequency of access. Similarly, the host side cache management software has analyzed the metadata and determined that the data extent 16 has either had a decrease in frequency of access or its frequency of access is lower than the new detected frequency of access for the data extent 31. Accordingly, host side cache management software decides to demote data extent 16 so that data extent 31 can occupy the portion of cache 120 that previously was occupied by data extent 16.

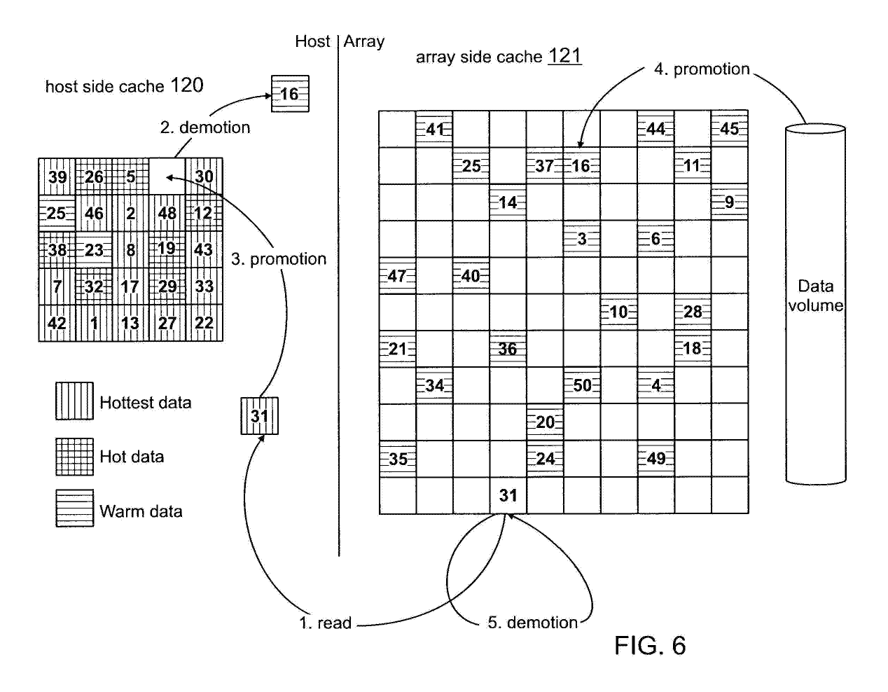

The operation of FIG. 6 includes the promotion of data extent 31 and demotion of data extent 16. Host side cache management software reads the data extent 31 from a data volume at the storage array in response to a host side cache miss. Host side cache management software then demotes the data extent 16 from its cache 120 and stores the data extent 31 to the host side cache 120. Demotion of data extent 16 includes evicting the data extent 16 from cache 120 and further includes the host side cache management software sending a command to the array side cache management software to cause the array side cache management software to promote the data 16 from the data volume to the array side cache 121. Also, since data extent 31 was promoted to the host side cache 120, the array side cache management software evicts data extent 31 from the array side cache 121. Thus, after the operation, data extent 31 is stored at cache 120, and data extent 16 is cached at array side cache 121. The operation ensures that the unified cache does not duplicate an entry, such as by caching the same data extent at both cache 120 and cache 121.

Also, it is noted that promotion and demotion are performed under control of the host side cache management software, which causes promotion and demotion both at cache 120 and cache 121. Array side cache management software receives instructions to promote or demote data extents from the host side cache management software, and it performs the promotion and demotion accordingly.

In the example of FIGS. 3-6, the application data working set includes a collection of data extents used by an application at a given time or during a given time window. The application working set may move when the application use case changes or application activities change. The variations of application working set may cause some data extents, which are demoted from the host side cache 120 and promoted to the array side cache 121, to be stored but then not subsequently accessed within a further time window. When array side cache management software receives data extent promotion commands from host side cache management software, the array side cache management software may reclaim some cache space on cache 121 using a least recently used (LRU) algorithm to demote cached data that is least recently used in order to make room for new data extent promotion.

FIG. 7 is an illustration of a software component block diagram for the systems of FIGS. 1 and 2, according to one embodiment. The software component block diagram of FIG. 7 shows an architecture 700 that may be used to perform the actions described above with respect to FIGS. 1-6.

In this example, the host cache management software 720 is a software component running on a host system, and it manages host side cache and primary data storage onto storage volumes 210. Host side cache management software 720 has interfaces for creating and constructing operating system storage cache devices that utilize cache devices, such as flash RAM devices, as data cache for backing primary storage devices (e.g., devices in a RAID). The software component 730 includes an action capture and event dispatcher. The responsibility of software component 730 is to capture actions and events from the host cache management software 720 and dispatch those events to host managed cache plug-in 731. Examples of events that may be captured and dispatched include cached device creation and construction, cached device decoupling, data extent promotion, data extent demotion, reporting if a corresponding data volume supports the host managed caching techniques of FIGS. 1-6. The action capture and event dispatcher 730 in this example includes an operation system specific component that is a thin layer for intercepting the events. Further in this example, the messages between component 730 and component 731 may be defined and encoded in a generic manner so that component 731 may service communications from different instances of the component 730.

The software component 731 is a host managed plug-in, and it accepts events and messages from the action capture and event dispatcher 730 and formats them to a proper format, such as SCSI pass-through commands. The operating system (OS) specific software component 732 (Action to scsi passthru command builder) understands one or more OS specific interfaces to issue a SCSI pass through command to a corresponding device. For instance, on a Linux platform, the OS specific SCSI pass-through interface may include a SG_IO interface.

The OS objects 733 are OS kernel objects which represent storage array volumes in the OS space, The component 732 forwards the SCSI pass-through commands ftom 731 to the correct storage array volume. The software component 735 resides in the storage array and is called “host managed adaptor” in this example. In this example, its responsibilities include 1) process host-managed SCSI pass-through commands ftom host side to the array side, 2) translate the SCSI pass-through commands to arrays side cache management action, and 3) issue cache management requests to the array side cache management software 721. The software component 721 resides in the storage array side in this example. In this embodiment, its responsibilities include 1) move data extents from a data volume to the array cache per requests from adaptor 735, 2) demotion of data extents in the array side cache per requests from adapter 735, and 3) enable/disable the host-managed cache feature of a given data volume per requests from adapter 735.

The actions performed by the example architecture 700 of FIG. 7 are described in more detail below with respect to Table 1. Of course, the particular architecture 700 and the actions of Table 1 are examples, and it is understood that the specific actions shown below may be adapted or modified for use in other systems to achieve the same result.

TABLE 1

| Event Name | Messages between | SCSI pass-through command | Array cache |
|---|---|---|---|
| from capturer | component 730 and | from component 731 to | manager 721 |
| 730 | component 731 | component 735 | action |
| Cached device | Message type: | If the volume is already has host- | Enable host- |
| construction | cached device | managed cache feature enabled, | managed cache |
| | construction msg | No-OP, | feature for the |
| | Message payload: | Otherwise, a scsi command | specified volume |
| | Storage array | addressed to the LUN/volume of | |
| | volume is used for | an array. The information in the | |
| | constructing this | command include | |
| | cached device | Enable host-managed | |
| | | cache feature | |
| | | The LBA range of the | |
| | | volume if it is not the | |
| | | entire capacity of the | |
| | | volume | |
| | | The possible scsi command could | |
| | | be | |
| | | Vendor specific log select | |
| | | log page | |
| | | Vendor specific command | |
| | | Or other scsi command | |
| | | This can also be configured via | |
| | | the array management interface. | |
| Cached device | Message type: | A scsi command addressed to the | Disable host- |
| destruction | cached device | LUN/volume of an array. The | managed cache |
| | destruction msg | information in the command | feature for the |
| | Message payload: | include | specified volume |
| | Storage array | disable host-managed | and demote array |
| | volume is used for | cache feature | side cached data |
| | this cached device | The LBA range of the | extents for the |
| | | volume if it is not the | volume |
| | | entire capacity of the | |
| | | volume | |
| | | The possible scsi command could | |
| | | be | |
| | | Vendor specific log select | |
| | | log page | |
| | | Vendor specific command | |
| | | Or other scsi command | |
| | | This can also be configured via | |
| | | the array management interface. | |
| Data extent | Message type: data | A scsi command addressed to the | Demote the data |
| promotion | extent promotion | LUN/volume of an array. The | extent from the |
| | msg | information in the command | arrays side cached |
| | Message payload: | include | data if the data |
| | Storage array | Arrays side cache | extent is in the |
| | volume is used for | operation request type: | array side cache. |
| | data extent | demotion from the array | Otherwise, no-op |
| | promotion. | side cache | |
| | Data extent | The LBA range(s) of the | |
| | descriptor (starting | volume which represents a | |
| | logic block address- | data extent or a list of data | |
| | LBA-and Length), | extents | |
| | | The possible scsi command could | |
| | | be | |
| | | Vendor specific log select | |
| | | log page | |
| | | Vendor specific command | |
| | | Or other scsi command | |
| Data extent | Message type: data | A scsi command addressed to the | Promote the data |
| demotion | extent demotion | LUN/volume of an array. The | extent to the |
| | msg | information in the command | arrays side cache |
| | Message payload: | include | |
| | Storage array | Array side cache operation | |
| | volume is used for | request type: promotion to | |
| | data extent | the array side cache | |
| | promotion. | The LBA range(s) of the | |
| | Data extent | volume which represents a | |
| | descriptor (starting | data extent or a list of data | |
| | LBA and Length | extents | |
| | | The possible scsi command could | |
| | | Vendor specific log select | |
| | | log page | |
| | | Vendor specific command | |
| | | Or other scsi command | |
| Reporting host- | Message type: | A scsi command addressed to the | Reporting host- |
| managed caching | volume host- | LUN/volume of an array. The | managed caching |
| attributes | managed caching | information return from the array | attributes to the |
| | attribute msg | include | host |
| | Message payload: | Where or not the host- | |
| | Storage array | managed caching feature | |
| | volume is used for | is supported | |
| | this cached device | Where or not the host- | |
| | Returned value: the | managed caching feature | |
| | volume's host- | is enabled | |
| | managed caching | if it is not the | |
| | attribute list. | entire capacity of | |
| | | the volume, | |
| | | reporting LBA | |
| | | range | |
| | | The possible scsi command could | |
| | | be | |
| | | Vendor specific log sense | |
| | | page | |
| | | Vendor specific command | |
| | | Or other scsi command | |

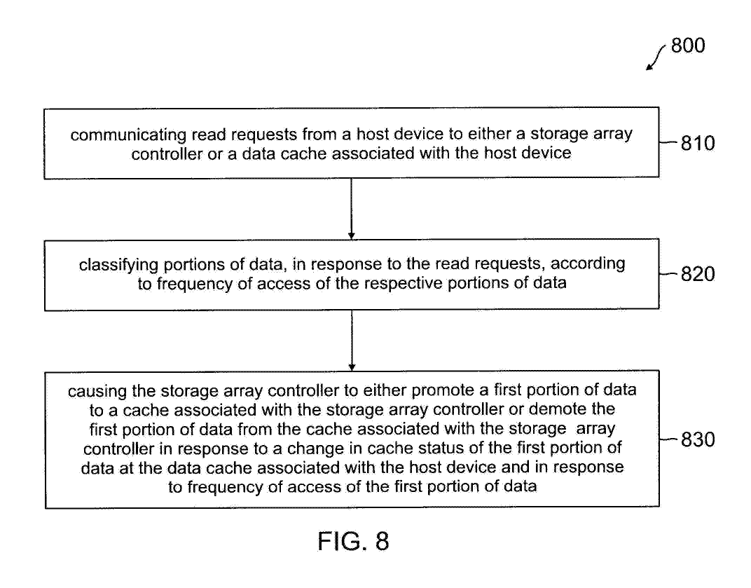

Turning now to FIG. 8, a flow diagram of a method 800 of caching read data across an array side cache and a host side cache is illustrated according to aspects of the present disclosure. In an embodiment, the method 800 may be implemented by one or more processors of one or more of the hosts 104 of FIGS. 1 and 2, executing computer-readable instructions to perform the functions described herein. For instance, actions attributable to the host may be performed by a host side cache management software, and actions attributable to the storage array controller may be performed by an array side cache management software, both of which are described above in more detail. It is understood that additional steps can be provided before, during, and after the steps of method 800, and that some of the steps described can be replaced or eliminated for other embodiments of the method 800. Method 800 provides a flowchart describing actions of FIGS. 3-6.

At action 810, the host communicates read requests to either a storage array controller or a data cache associated with the host device. With the caching available, most of the read requests will be satisfied from a data cache associated with the host device or the data cache associated with the storage array controller. An example of a data cache associated with the host device includes cache 120 of FIGS. 1 and 2, and an example of a data cache associated with a storage array controller includes cache 121 of FIGS. 1 and 2. If a read request is not satisfied from a data cache, the storage system may provide the requested data from the primary storage of the storage array.

At action 820, the host classifies portions of data, in response to the read requests, according to a frequency of access of the respective portions of data. An example of a portion of data includes a data extent, which is a given Logical Block Address (LBA) plus a number of blocks (data block length). The LBA defines where the data extent starts and the block length specifies the size of the data extent. Of course, the scope of embodiments is not limited to any particular method to define a size or location of a portion of data, as any appropriate data addressing scheme may be used. Continuing with the example, during normal operation of the host device, the host device submits numerous read and write requests. For each of those read requests, the host tracks a frequency of access by maintaining and modifying metadata to indicate frequency of access of individual portions of data. The host device then analyzes that metadata to identify portions of data that are accessed more frequently than other portions of data, and may even classify portions of data into multiple categories, such as hottest, hot, and warm. An example of such categories as provided above with respect to FIGS. 3-6, where data is classified as hottest, hot, and warm. Such categories may be based upon preprogrammed threshold's or dynamic thresholds for frequency of access, where data having a frequency of access higher than a highest threshold is indicated as hottest, and lower thresholds define the categories for hot and warm. Of course, various examples may use any categories that are appropriate, any thresholds that are appropriate, and any techniques to manage and analyze metadata. The host may store this metadata at any appropriate location, including at volatile or nonvolatile memory at the host device or at another device accessible by the host device.

At decision block 830, the host device causes the storage array controller to either promote a first portion of data to a cache associated with the storage array controller or demote the first portion of data from the cache associated with the storage array controller. An example of causing the storage array controller to promote a portion of data is shown in FIG. 6, where the host sends a command to the array, thereby causing the array side cache management software to promote data portion 16 from the data volume to the array side cache 121. An example of causing the storage array controller to demote a portion of data is shown in. FIG. 6 as well, where the host sends a command to the array, thereby causing the array side cache management software to evict data portion 31 from the array side cache 121.

The action at block 830 is performed in response to a change in cache status of the first portion of data at the data cache associated with the host device and in response to frequency of access of the first portion of data. For instance, in FIG. 6 the promotion of data portion 16 from primary storage at the data volume to the array side cache 121 is performed in response to the demotion of data portion 16 at the host side cache 120. Furthermore, demotion of data portion 31 from the array side cache 121 is performed in response to promotion of data portion 31 at the host side cache 120. In other words, the cache status including whether a data portion is promoted, demoted, or currently stored at the host side cache 120 affects promotion or demotion of the data portion at the array side cache 121.

Additionally, the promotion or demotion at block 830 is also performed in response to a frequency of access of that portion of data. Specifically, with respect to the example of FIGS. 3-6, the data items are promoted or demoted based upon a detected frequency of access. As described above, with respect to action 820, the frequency of access or a change in classification based on a frequency of access is tracked by the host. The host then either promotes or demotes portions of data based on a change in frequency of access or change in classification. The host and detects changes in frequency of access or changes in classification by maintaining and modifying metadata, as described further above.

The scope of embodiments is not limited to the actions shown in FIG. 8. Rather, other embodiments may add, omit, rearrange, or modify various actions. For instance, the host device may further promote or demote portions of data from its own cache—the host side cache. As shown in the examples of FIGS. 3-6, promotion or demotion at the host side cache is often performed in coordination with promotion or demotion at the array side cache as well.

Various embodiments described herein provide advantages over prior systems and methods. For instance, various embodiments use the cache in the storage array as an extension of the host side cache to implement a unified cache system. When an application I/O request misses the host side cache data, it may hit the array side cache. In this way, the majority of application I/O requests may be served from host side cache device with lowest I/O latency. The I/O requests which the host side cache misses may be served from array side cache device. The overall I/O latency can be controlled under the I/O latency of the array side cache. Additionally, the integration solution may be simple and effective by employing a thin software layer on the host side cache management and a thin software layer on the storage array side.

The present embodiments can take the form of hardware, software, or both hardware and software elements, In that regard, in some embodiments, the computing system is programmable and is programmed to execute processes including the processes of method 800 discussed herein. Accordingly, it is understood that any operation of the computing system according to the aspects of the present disclosure may be implemented by the computing system using corresponding instructions stored on or in a non-transitory computer readable medium accessible by the processing, system. For the purposes of this description, a tangible computer-usable or computer-readable medium can be any apparatus that can store the program for use by or in connection with the instruction execution system, apparatus, or device. The medium may include for example non-volatile memory including magnetic storage, solid-state storage, optical storage, cache memory, and Random Access Memory (RAM).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method comprising:
communicating read requests from a host device to a data cache managed by the host device and to a storage array controller of a storage system when the data responsive to the read requests is not stored in the data cache managed by the host device;
classifying portions of data, in response to the read requests, according to frequency of access of the respective portions of data; and
causing the storage array controller to either promote a first portion of data to be stored in a data cache managed by the storage array controller or demote a second portion of data from the storage in the data cache managed by the storage array controller in response to a change in cache status of the first portion of data at the data cache managed by the host device and in response to frequency of access of the first portion of data.

2. The method of claim 1, wherein the portions of data comprise data extents.

3. The method of claim 2, wherein the data extents are defined by Logical Block Addresses (LBAs).

4. The method of claim 1, wherein causing the storage array controller to promote the first portion of data to the data cache managed by the storage array controller comprises:
sending a message from the host device to a cache management component of the storage array controller, the message instructing the cache management component to promote the first portion of data, wherein the host device sends the message in response to demoting the first portion of data from the data cache managed by the host device.

5. The method of claim 4, wherein demoting the first portion of data from the data cache managed by the host device is performed in response to promoting a second portion of data to the data cache managed by the host device.

6. The method of claim 1, wherein causing the storage array controller to demote the second portion of data from the cache managed by the storage array controller comprises:
sending a message from the host device to a cache management component of the storage array controller, the message instructing cache management component to demote the second portion of data stored in the data cache managed by the storage array controller, wherein the host device sends the message in response to promoting the second portion of data to the data cache managed by the host device.

7. The method of claim 6, wherein promoting the second portion of data to the data cache managed by the host device comprises reading the second portion of data from an array managed by the storage array controller.

8. The method of claim 6, wherein promoting the second portion of data to the data cache managed by the host device is performed in response to determining that the second portion of data has experienced an increase in its frequency of access.

9. The method of claim 1, wherein classifying portions of data comprises classifying the portions of data into a first category, a second category, and a third category, wherein each of the first, second, and third categories are defined by thresholds of frequency of access.

10. A computing device, comprising:
a memory containing machine readable medium comprising machine executable code having stored thereon instructions for performing a method of managing data caching at a first data cache managed by a host device and at a second data cache managed by a storage array controller of a storage system; and
a processor coupled to the memory, the processor configured to execute the machine executable code to:
classify portions of data according to read access frequencies of the respective portions of data, the portions of data including a first portion of data;
determine that the first portion of data should be removed from the first data cache in accordance with a read access frequency of the first portion of data;
in response to determining that the first portion of data should be removed from the first data cache, send a command to the storage array controller of the second data cache which causes the storage array controller to cache the first portion of data at the second data cache.

11. The computing device of claim 10, wherein the portions of data comprise data extents.

12. The computing device of claim 11, wherein the data extents are defined by Logical Block Addresses (LBAs).

13. The computing device of claim 10, wherein determining that the first portion of data should be removed from the first data cache comprises:
demoting the first portion of data in response to promoting a second portion of data.

14. The computing device of claim 10, wherein the processor is further configured to execute the machine readable code to:
determine that a second portion of data should be promoted to the first data cache in accordance with a read access frequency of the second portion of data; and
in response to determining that the second portion of data should be promoted, send a command to the storage array controller of the second data cache to evict the second portion of data from the second data cache.

15. The computing device of claim 10, wherein classifying portions of data comprises:
classifying the portions of data into a first category, a second category, and a third category, wherein each of the first, second, and third categories are defined by thresholds of frequency of access.

16. A non-transitory machine readable medium having stored thereon instructions for performing a method of managing data caching at a first data cache managed by a host device and at a second data cache managed by a storage array controller of a storage system, comprising machine executable code which when executed by at least one machine, causes the machine to:
classify portions of data according to read access frequencies of the respective portions of data, the portions of data including a first portion of data;
determine that the first portion of data should be removed from the first data cache in accordance with a read access frequency of the first portion of data;
evict the first portion of data from the first data cache in response to determining that the first portion of data should be removed;
send a command to the storage array controller of the second data cache to cache the first portion of data at the second data cache in response to determining that the first portion of data should be removed from the first data cache; and
after evicting the first portion of data from the first data cache, promote a second portion of data to the first data cache in response to a read access frequency of the second portion of data.

17. The non-transitory machine-readable medium of claim 16, wherein the portions of data comprise data extents.

18. The non-transitory machine-readable medium of claim 17, wherein the data extents are defined by Logical Block Addresses (LBAs).

19. The non-transitory machine-readable medium of claim 16, wherein classifying portions of data comprises:
classifying the portions of data into a first category, a second category, and a third category, wherein each of the first, second, and third categories are defined by thresholds of frequency of access.

20. The non-transitory machine-readable medium of claim 16, wherein promoting the second portion of data is performed in response to determining that the read access frequency of the second portion of data has increased.
